(19) United States
(12) Patent Application Publication
(10) Pub. No.: US 2016/0300416 A1
(43) Pub. Date: Oct. 13, 2016

(54) Electronic Lock and Verification Method for Unlocking the Same

(71) Applicant: Smart Approach Co., Ltd., Zhubei City (TW)

(72) Inventors: Hsin-Lung Lin, Zhubei City (TW); Che-An Chiang, Zhubei City (TW)

(21) Appl. No.: 14/950,028

(22) Filed: Nov. 24, 2015

(30) Foreign Application Priority Data
Apr. 7, 2015 (TW) 104111170

(51) Int. Cl. G07C 9/00; H04B 5/00

(52) U.S. Cl. CPC G07C 9/00309; H04B 5/0056; G07C 2009/00325; G07C 2009/00769

(57) ABSTRACT

An electronic lock is provided. The electronic lock includes an unlocking data writing unit, a wireless data reading head, a security element, a storage unit, a microcontroller and a gate lock control unit. The unlocking data writing unit is to provide a user to enter at least one verified data. The wireless data reading head is configured to read an unlocking data of a data carrier. The security element is configured to encode or decode the verified data. The microcontroller is electrically connected to the unlocking data writing unit, the wireless data reading head, the security element, the storage unit and the gate lock control unit. According to an instruction of the microcontroller, the gate lock control unit is configured to lock or unlock the electronic lock.

### BACKGROUND OF THE INVENTION

1. Field of the Invention

The present invention relates to a field of electronic technology, more particularly to an electronic lock having encrypting function and a verified method using such a device.

2. Description of the Prior Art

In the past, a door lock in the house is a kind of mechanical structure. A user has to use a corresponding key to turn on the door lock. In recent years, password locks and inductive electronic locks are widely used to apartments or office buildings because electronic technology has greatly been advanced. The password lock would save at least one password, and the user needs to enter the correct password for turning on the password lock. Furthermore, the user has to use a corresponding proximity card to turn on the inductive electronic lock. In Taiwan, the proximity card is classified into three kinds: MiFARE (Commonly known as a copy-protection type of proximity card), EM (Commonly known as a no copy-protection type of proximity card) and HID. The kind of early proximity cards are mainly EM proximity cards. In recent years, numbers of the MiFARE proximity card is becoming more and more because the EM proximity card is easy to be copied and the MiFARE proximity card is not easy to be copied. About HID proximity card whose number is on the decline.

From the above, the inductive electronic lock similarly needs to save at least one verified data. The verified data would be the same as an unlocking data of the proximity card. And then, when the proximity card closes to the inductive electronic lock, the verified data would be compared with the unlocking data by the inductive electronic lock. When the verified data is the same as the unlocking data, the inductive electronic lock will be turned on. In addition, the verified data and the unlocking data for example is an outer code, an internal code or a serial number of the proximity card.

In contrast to unlocking method of traditional keys, the inductive electronic lock is convenient to the user. However, the inductive electronic lock still has the following drawbacks:

1. If the verified data of the inductive electronic lock is stolen by external people, the external people can use the verified data to make a corresponding proximity card. As a result, the inductive electronic lock's security has big problems.

2. The unlocking data of the proximity card is usually only one serial number or only one password so it is easy to be cracked or guessed.

Therefore, how to reform the above drawbacks is worth considering to a person having ordinary skill in the art.

### SUMMARY OF THE INVENTION

One object of the present invention is to provide an electronic lock so as to solve the problems of the traditional inductive electronic lock, and the electronic lock could increase the safety of an entrance.

One object of the present invention is to provide an electronic lock. The electronic lock includes an unlocking data writing unit, a wireless data reading head, a security element, a storage unit, a microcontroller and a gate lock control unit. The unlocking data writing unit is to provide a user to enter a verified data. The wireless data reading head configured to read an unlocking data of a data carrier. The security element configured to encrypt or decrypt the verified data. The microcontroller electrically connected to the unlocking data writing unit, the wireless data reading head, the security element and the storage unit. The gate lock control unit electrically is connected to the microcontroller, wherein according to an instruction of the microcontroller, the gate lock control unit locks or unlocks the electronic lock.

In the aforementioned electronic lock, wherein the unlocking data is a number selected from the group consisting of a custom password of an application in a handheld electronic device, a serial number of a handheld electronic device, a serial number of a SIM card, and a media access control address of a wireless network equipment.

In the aforementioned electronic lock, wherein the microcontroller is configured to confirm if the unlocking data is the same as the verified data decrypted.

A verified method for unlocking an electronic lock method comprises the following steps:
(a) reading at least one verified data;
(b) encrypting the verified data to generate a first encrypted archive;
(c) reading an unlocking data of a data carrier;
(d) converting the first encrypted archive into the verified data;
(e) comparing the unlocking data and the verified data decrypted, and if the unlocking data is the same as the verified data decrypted, proceed with the step “f”, and if the unlocking data is not the same as the verified data decrypted , proceed with the step “g”;
(f) unlocking the electronic lock;
(g) transmitting a no unlocking warning.

A verified method for unlocking an electronic lock comprises the following steps:
(a) reading at least one verified data;
(b) encrypting the verified data to generate a first encrypted archive;
(c) reading an unlocking data of a data carrier;
(d) encrypting the unlocking data to generate a second encrypted archive;
(e) comparing the second encrypted archive and the first encrypted archive, and if the second encrypted archive is the same as the first encrypted archive, proceed with the step “f”, and if the unlocking data is not the same as the first encrypted archive, proceed with the step “g”;
(f) unlocking the electronic lock;
(g) transmitting a no unlocking warning.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 illustrates a schematic diagram of the electronic lock system 1 in accordance with an embodiment of the present invention;

FIG. 2 illustrates a schematic diagram of a data carrier 11 setting an unlocking data 110;

FIG. 3 illustrates a schematic diagram of the electronic lock system 2 in accordance with another embodiment of the present invention;

FIG. 4 illustrates a flow diagram of verified method S100 for unlocking the electronic lock 12 in accordance with an embodiment of the present invention; and

FIG. 5 illustrates a flow diagram of verified method S200 for unlocking the electronic lock 12 in accordance with an embodiment of the present invention.

### DESCRIPTION OF THE PREFERRED EMBODIMENTS

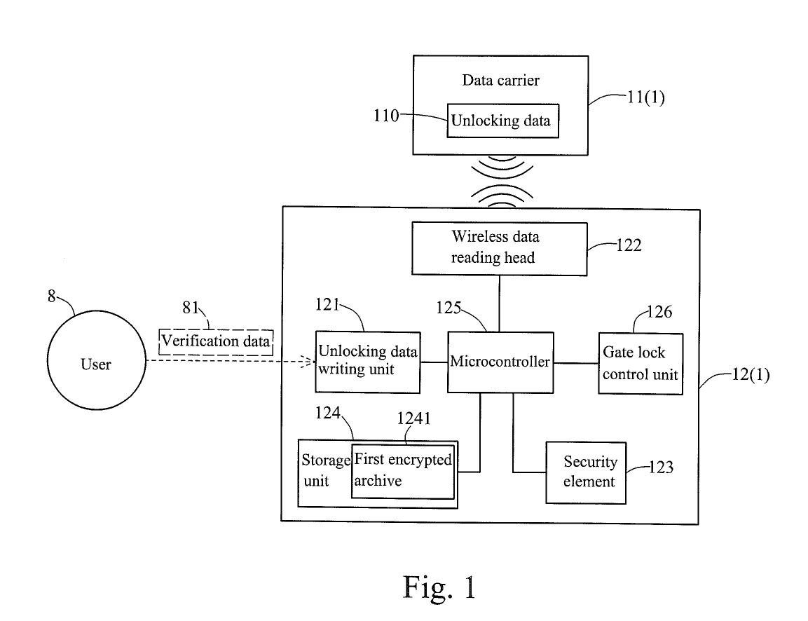

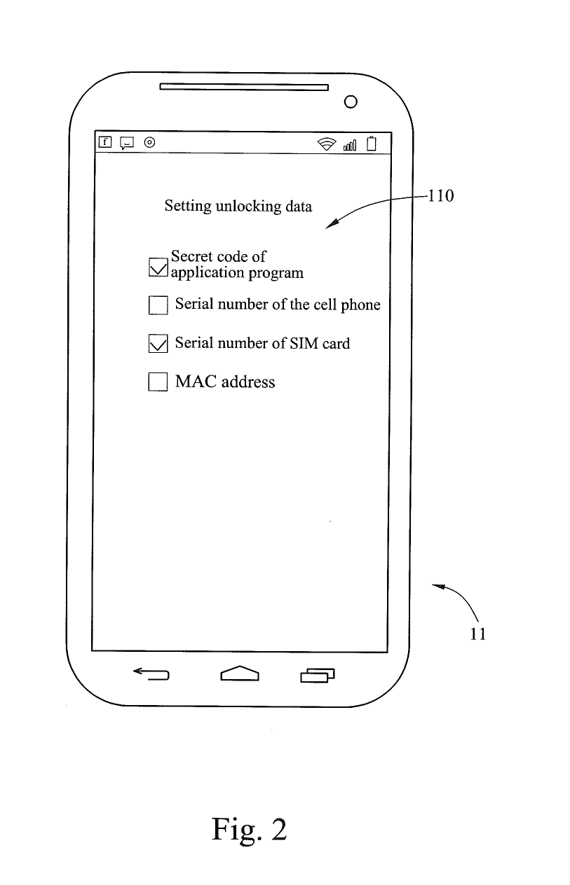

Please refer to FIG. 1. FIG. 1 illustrates a schematic diagram of the electronic lock system 1 in accordance with an embodiment of the present invention. The electronic lock system 1 includes at least one data carrier 11 and an electronic lock 12. The data carrier 11 includes a unlocking data 110 and the data carrier 11 for example is a handheld electronic device comprising a NFC function or a proximity card comprising a NFC function. The handheld electronic device is a smart phone or a smart watch. The electronic lock 12 includes an unlocking data writing unit 121, a wireless data reading head 122, a security element 123, a storage unit 124 and a gate lock control unit 126. The unlocking data writing unit 121 is to provide a user to enter a verified data 8. The verified data 81 is the same as the unlocking data 110 of the data carrier 11. The unlocking data 110 is a number selected from the group consisting of a custom password of an application in a handheld electronic device, a serial number of a handheld electronic device, a serial number of a SIM card, and a media access control address of wireless network equipment. In addition, please refer to FIG. 2. FIG. 2 illustrates a schematic diagram of a data carrier 11 setting an unlocking data 110. In the example of FIG. 2, the custom password of the application (APP) and the serial number of the SIM card are all checked, so the unlocking data 110 consists of the custom password of the application (APP) and the serial number of the SIM card. However, person having ordinary skill in the art could understand the custom password of the application (APP), the serial number in the handheld electronic device, the serial number of the SIM card and the media access control address could arbitrarily be checked in order to generate the unlocking data 110. In contrast to the traditional inductive electronic lock, the unlocking data 110 of the electronic lock system 1 includes a plurality of serial numbers or a plurality of passwords, so that the electronic lock system 1 could increase the safety and is not easy to be cracked.

Moreover, the wireless data reading head 122 is configured to read the unlocking data 110 of the data carrier 11 into the microcontroller 125. The wireless data reading head 122 for example is a reading head of Near Field Communication (NFC). The security element 123 is configured to encrypt the verified data 81 entered. And then, the verified data 81 encrypted becomes a first encrypted archive 1241. The first encrypted archive 1241 is saved in the storage unit 124. According to an instruction of the microcontroller, the gate lock control unit 126 unlocks the electronic lock or transmits a no unlocking warning. From the above, the security element 123 could convert the verified data 81 into the first encrypted archive 1241, and the security element 123 could also convert the first encrypted archive 1241 into the verified data 81. For example, when the unlocking data 110 is read by the wireless data reading head 122, the security element 123 would convert the first encrypted archive 1241 into the verified data 81. Furthermore, the microcontroller 125 is configured to confirm if the unlocking data 110 is the same as the verified data 81. If the confirmed result is “Yes”, the microcontroller 125 will transmit an unlocking warning to the gate lock control unit 126. In contrast to the traditional inductive electronic lock, the security element 123 of the electronic lock system 1 would make the verified data 81 become a first encrypted archive 1241. Therefore, even though the first encrypted archive 1241 is stolen, the first encrypted archive 1241 is not easy to return to the verified data 81. As a result, it is hard to divulge the verified data 81.

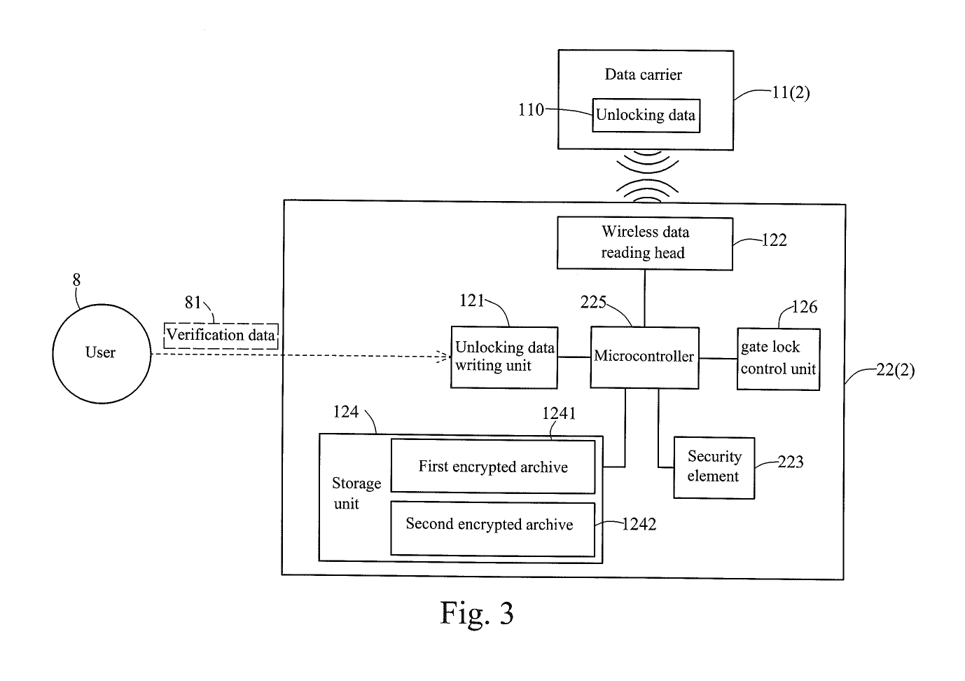

Please refer to FIG. 3. FIG. 3 illustrates a schematic diagram of the electronic lock system 2 in accordance with another embodiment of the present invention. The electronic lock system 2 includes at least one verification data 11 and electronic lock 22. The difference between the electronic lock system 2 and the electronic lock system 1 is the security element 223 of the electronic lock 22 is instead of the security element 123, and the microcontroller 225 of the electronic lock 22 is instead of the microcontroller 125. The security element 223 is also configured to encrypt the unlocking data 110 of the verification data 11. And then, the unlocking data 110 encrypted becomes a second encrypted archive 1242. The second encrypted archive 1242 is saved in the storage unit 124. The microcontroller 225 is configured to confirm if the second encrypted archive 1242 is the same as the first encrypted archive 1242. If the confirmed result is “Yes”, the microcontroller 225 will transmit an unlocking warning to the gate lock control unit 126.

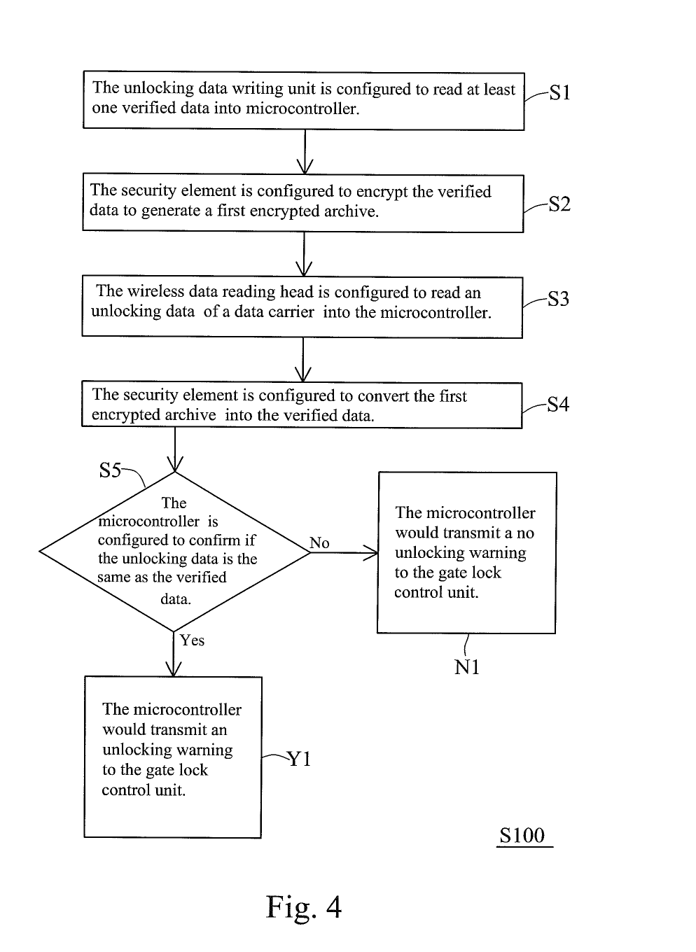

Please refer to FIG. 4. FIG. 4 illustrates a flow diagram of verified method S100 for unlocking the electronic lock 12 in accordance with an embodiment of the present invention. The verified method S100 for unlocking an electronic lock 12 comprises the following steps: First, as described in step S1. The unlocking data writing unit 121 is configured to read at least one verified data 81 into microcontroller 125. Next, as described in step S2. The security element 123 is configured to encrypt the verified data 81 to generate a first encrypted archive 1241. And then, as described in step S3. The wireless data reading head 122 is configured to read an unlocking data 110 of a data carrier 11 into the microcontroller 125. And then, as described in step S4. The security element 123 is configured to convert the first encrypted archive 1241 into the verified data 81. And then, as described in step S5. The microcontroller 125 is configured to confirm if the unlocking data 110 is the same as the verified data 81. If the confirmed result is “Yes”, proceed with the step “Y1”. The microcontroller 125 would transmit an unlocking warning to the gate lock control unit 126. If the confirmed result is “No”, proceed with the step “N1”. The microcontroller 125 would transmit a no unlocking warning to the gate lock control unit 126. Moreover, because the verified data 81 becomes the first encrypted archive 1241 in step S2, the first encrypted archive 1241 stolen is not easy to return to the verified data 81. As a result, the external people cannot make a corresponding proximity card to turn on the electronic lock 12.

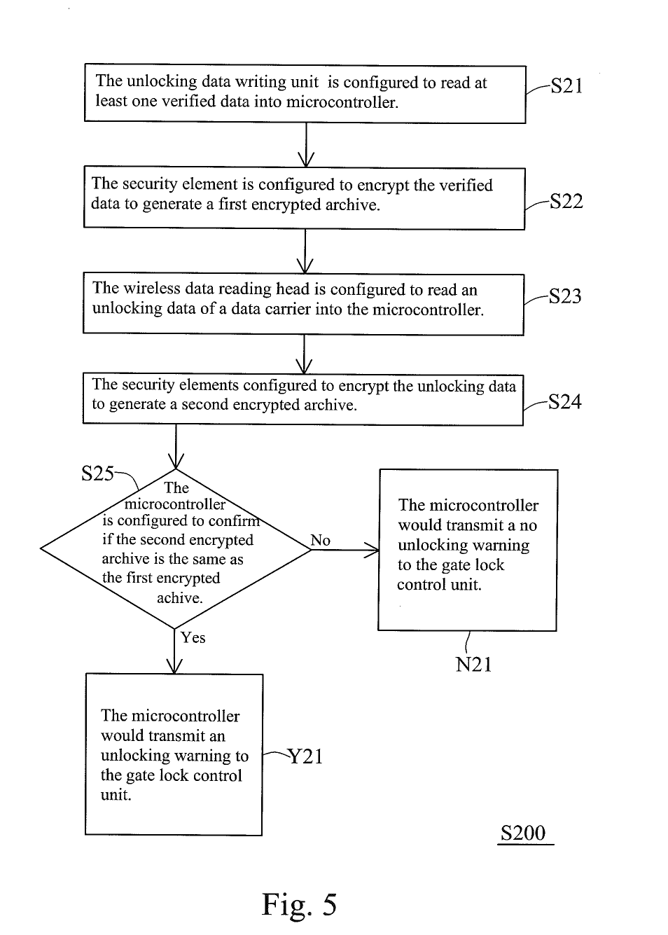

Please refer to FIG. 5. FIG. 5 illustrates a flow diagram of verified method for unlocking the electronic lock 12 in accordance with an embodiment of the present invention. The verified method S200 for unlocking an electronic lock 12 comprises the following steps: First, as described in step S21. The unlocking data writing unit 121 is configured to read at least one verified data 81 into microcontroller 125. Next, as described in step S22. The security element 223 is configured to encrypt the verified data 81 to generate a first encrypted archive 1241. And then, as described in step S23. The wireless data reading head 122 is configured to read an unlocking data 110 of a data carrier 11 into the microcontroller 225. And then, as described in step S24. The security element 123 is configured to encrypt the unlocking data 110 to generate a second encrypted archive 1242. And then, as described in step S25. The microcontroller 225 is configured to confirm if the second encrypted archive 1242 is the same as the first encrypted archive 1241. If the confirmed result is “Yes”, proceed with the step “Y21”. The microcontroller 225 would transmit an unlocking warning to the gate lock control unit 126. If the confirmed result is “No”, proceed with the step “N21”. The microcontroller 225 would transmit a no unlocking warning to the gate lock control unit 126. Moreover, because the verified data 81 becomes the first encrypted archive 1241 in step S22 and the verified data 110 becomes the second encrypted archive 1242 in step S24, the first encrypted archive 1241 stolen and the second encrypted archive 1242 stolen are not easy to return to. As a result, the electronic lock 12 is safer.

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

I claim:

1. An electronic lock comprising:
an unlocking data writing unit, wherein the unlocking data writing unit is to provide a user to enter a verified data;
a wireless data reading head configured to read a unlocking data of a data carrier;
a security element configured to encrypt or decrypt the verified data;
a storage unit;
a microcontroller electrically connected to the unlocking data writing unit, the wireless data reading head, the security element and the storage unit; and
a gate lock control unit electrically connected to the microcontroller;
wherein according to an instruction of the microcontroller, the gate lock control unit locks or unlocks the electronic lock.

2. The electronic lock of claim 1, wherein the data carrier is a handheld electronic device comprising a NFC function or a proximity card comprising a NFC function.

3. The electronic lock of claim 2, wherein the handheld electronic device is a smart phone or a smart watch.

4. The electronic lock of claim 1, wherein the wireless data reading head is a Near Field Communication reading head.

5. The electronic lock of claim 1, wherein the unlocking data is a number selected from the group consisting of a custom password of an application in a handheld electronic device, a serial number of a handheld electronic device, a serial number of a SIM card, and a media access control address of a wireless network equipment.

6. The electronic lock of claim 1, wherein the microcontroller is configured to confirm if the unlocking data is the same as the verified data decrypted.

7. The electronic lock of claim 1, wherein the storage unit is configured to save the verified data encrypted and the unlocking data encrypted.

8. A verified method for unlocking an electronic lock, comprising:
(a) reading at least one verified data;
(b) encrypting the verified data to generate a first encrypted archive;
(c) reading an unlocking data of a data carrier;
(d) converting the first encrypted archive into the verified data;
(e) comparing the unlocking data and the verified data decrypted, and if the unlocking data is the same as the verified data decrypted, proceed with the step “f”, and if the unlocking data is not the same as the verified data decrypted, proceed with the step “g”;
(f) unlocking the electronic lock;
(g) transmitting a no unlocking warning.

9. The verified method of claim 8, wherein the unlocking data is a number selected from the group consisting of a custom password of an application in a handheld electronic device, a serial number of a handheld electronic device, a serial number of a SIM card, and a media access control address of a wireless network equipment.

10. A verified method for unlocking an electronic lock, comprising:
(a) reading at least one verified data;
(b) encrypting the verified data to generate a first encrypted archive;
(c) reading an unlocking data of a data carrier;
(d) encrypting the unlocking data to generate a second encrypted archive;
(e) comparing the second encrypted archive and the first encrypted archive, and if the second encrypted archive is the same as the first encrypted archive, proceed with the step “f”, and if the unlocking data is not the same as the first encrypted archive , proceed with the step “g”;
(f) unlocking the electronic lock;
(g) transmitting a no unlocking warning.

11. The verified method of claim 10, wherein the unlocking data is a number selected from the group consisting of a custom password of an application in a handheld electronic device, a serial number of a handheld electronic device, a serial number of a SIM card, and a media access control address of a wireless network equipment.
